(19) United States
(12) Patent Application Publication
(10) Pub. No.: US 2006/0293412 A1
(43) Pub. Date: Dec. 28, 2006

(54) Ink composition and manufacturing method of color filters

(75) Inventor: Ching-Yu Chou, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu City (TW)

(21) Appl. No.: 11/450,254

(22) Filed: Jun. 9, 2006

(30) Foreign Application Priority Data
Jun. 24, 2005 (CN) 200510035534.9

(51) Int. Cl. C03C 17/00

(52) U.S. Cl. 523/160

(57) ABSTRACT

An ink composition includes a colorant, a solvent, and at least one component selected from the group consisting of monomer, oligomer, and macromolecule resin. The vapor pressure of the solvent is smaller than 0.33 mmHg at 20° C., but when the temperature of the solvent is between 60° C. and 90° C., the vapor pressure thereof increases at least five times than that of the solvent at 20° C. and/or the evaporation rate is larger than one tenth of that of butyl acetate at 20° C. The ink composition has excellent practicability. A manufacturing method of color filter using the ink composition includes the steps of: providing a transparent substrate; forming a black matrix on the transparent substrate; forming a plurality of banks on the black matrix; ejecting the ink composition into spaces defined by the banks via an ink jet device; and solidifying the ink composition.

### BACKGROUND

1. Technical Field

The present invention relates to an ink composition of color filters and a manufacturing method of color filters using the ink composition and, more particularly, to an ink composition for manufacturing color filters by an ink-jet system.

2. Description of the Related Art

A color filter is an important element of a liquid crystal display (LCD). The color filter is used for improving picture quality and providing a primary color to each sub-pixel of the LCD. The color filter generally includes a glass substrate, a black matrix formed on a surface of the glass substrate, a color layer formed of red (R) color portions, green (G) color portions and blue (B) color portions, and a transparent electrically conductive layer covering the black matrix and the color layer. The black matrix defines a plurality of sub-pixels of the color filter. Every sub-pixel accommodates one color portion chosen from R, G, and B color portions.

The color filters are generally manufactured via a method called “pigment-dispersed method”. The normal process of pigment-dispersed method has four repeated cycles. Wherein, each cycle contains a spin coating process or slit coating process for one selected color, a pre-bake and exposing process to solidify the selected color position to be a uniform color layer, a developing process to transform the uniform color layer to be a patterned film, and a heating process to transform the patterned film to be a solidified layer. After one color cycle is finished, another color cycle is performed. Therefore, four cycles are repeated to be the black matrix, red color portion, blue color portion, and green color portion. Since, total processing steps will be more than 25 steps, the processing cost is high.

A newer manufacturing method for color filters is an ink jet method. The ink jet method mainly includes a step of ejecting an ink composition onto a transparent substrate by an ink jet head to deposit the ink composition on prescribed areas defined by a black matrix. The ink composition used in the ink jet system must have special performances, such as an appropriate drying rate so that tiny nozzles of ink jet head will not be blocked due to a high drying rate of ink composition. Therefore, U.S. Pat. No. 6,627,364 proposes an ink composition adopts a slow drying solvent or its mixture having a boiling point of 245° C. (.degree. C.) or more at normal pressure. However, such drying rate of the solvent is too low so that the manufacturing speed of the color filters using the ink composition is slow for practicality.

What is needed, therefore, is an ink composition that can improve the manufacturing speed of the color filters with proper property preventing the problem of blocking nozzles of ink jet head.

### SUMMARY

An ink composition according to a first preferred embodiment includes a colorant, a solvent, and at least one component selected from the group consisting of monomer, oligomer, and macromolecule resin. The vapor pressure of the solvent is smaller than 0.33 mmHg at 20° C., but when the temperature of the solvent is between 60° C. and 90° C., the vapor pressure thereof increases at least five times than that of the solvent at 20° C. and/or the evaporation rate is larger than one tenth of that of butyl acetate at 20° C. Thus, the ink composition has excellent practicability.

An ink composition according to a second preferred embodiment includes a colorant, a mixed solvent, and at least one component selected from the group consisting of monomer, oligomer, and macromolecule resin. The vapor pressure of the mixed solvent is smaller than 0.33 mmHg at 20° C., but when the temperature of the mixed solvent is between 60° C. and 90° C., the vapor pressure thereof increases at least five times than that of the mixed solvent at 20° C. and/or the evaporation rate is larger than one tenth of that of butyl acetate at 20° C. The ink composition has excellent practicability.

A manufacturing method of a color filter using the ink composition according to a third preferred embodiment includes the steps of: providing a transparent substrate; forming a black matrix on the transparent substrate; forming a plurality of banks on the black matrix; ejecting the ink composition into spaces defined by the banks via an ink jet device; and solidifying the ink composition.

A manufacturing method of a color filter using the ink composition according to a fourth preferred embodiment includes the steps of: providing a transparent substrate; forming a black matrix on the transparent substrate; forming an ink receive layer between the portions of the black matrix; ejecting the ink composition into the ink receive layer; and solidifying the ink composition.

A manufacturing method of a color filter using the ink composition according to a fifth preferred embodiment includes the steps of: providing a transparent substrate; forming a black matrix as banks on the transparent substrate; ejecting the ink composition into spaces defined by the banks via an ink jet device; and solidifying the ink composition.

Other advantages and novel features will become more apparent from the following detailed description of present ink composition and method, when taken in conjunction with the accompanying drawings.

### BRIEF DESCRIPTION OF THE DRAWINGS

Many aspects of the present ink composition and method can be better understood with reference to the following drawings. The components in the drawings are not necessarily to scale, the emphasis instead being placed upon clearly illustrating the principles of the present ink composition and method. Moreover, in the drawings, like reference numerals designate corresponding parts throughout the several views.

FIG. 1 is a flowchart of a manufacturing method of a color filter in accordance with a first embodiment;

FIGS. 2a to 2f are schematic cross-sectional views illustrating the manufacturing method of FIG. 1;

FIG. 3 is a flowchart of a manufacturing method of a color filter in accordance with a second embodiment;

FIG. 4 is a flowchart of a manufacturing method of a color filter in accordance with a third embodiment; and

FIGS. 5a to 5d are schematic cross-sectional views illustrating the manufacturing method of FIG. 4.

### DETAILED DESCRIPTION OF PREFERRED EMBODIMENTS

The present ink composition of color filters includes a colorant, a solvent, and at least one component selected from the group consisting of monomer, oligomer and macromolecule resin. The total amount of the colorant in the ink composition ranges preferably from 0.1% to 30% by weight (wt), more preferably from 2% to 15% by weight. The total amount of the solvent in the ink composition ranges preferably from 15% to 95% by weight, more preferably from 60% to 85% by weight. The total amount of the at least one component selected from the group consisting of monomer, oligomer and macromolecule resin in the ink composition ranges preferably from 1% to 80% by weight, more preferably from 5% to 30% by weight. Follows are detail description of the present ink composition.

The colorant used in the present ink composition is not limited to a particular color. It is suitably selected according to the application purpose of the color filter, and may be a pigment, dye or natural coloring matter or the mixture of the above. The colorant preferably has a high color gamut and a high heat resistance. A pigment is generally used because of its high permanence of color, and an organic pigment is particularly preferably used. Illustrative examples of the organic pigment are compounds classified into a group of pigments according to color index (C.I.; The Society of Dyers and Colourists). Specifically, the organic pigment are compounds having the following color index numbers: C.I. Pigment Red 122, C.I. Pigment Red 177, C.I. Pigment Red 185, C.I. Pigment Red 202, C.I. Pigment Red 206, C.I. Pigment Red 207, C.I. Pigment Red 209, C.I. Pigment Red 224, C.I. Pigment Red 254, C.I. Pigment Red 264, C.I. Pigment Blue 15:3, C.I. Pigment Blue 15:4, C.I. Pigment Blue 15:6, C.I. Pigment Green 7, C.I. Pigment Green 36, C.I. Pigment Yellow 74, C.I. Pigment Yellow 83, C.I. Pigment Yellow 110, C.I. Pigment Yellow 138, C.I. Pigment Yellow 139, C.I. Pigment Yellow 150, C.I. Pigment Yellow 151, C.I. Pigment Yellow 155, C.I. Pigment Yellow 180, C.I. Pigment Yellow 213, C.I. Pigment Orange 38, C.I. Pigment Orange 73, C.I. Pigment Brown 24, C.I. Pigment Violet 19, or C.I. Pigment Violet 23. Of course, other appropriate colorants can also be used in the present ink composition.

The at least one component selected from the monomer, oligomer and macromolecule resin can be reactive or non reactive. The reactive component generally includes a structure of unsaturated carbon-carbon double bonds. A preferable choice for the reactive component is monomer and oligomer. The monomer can be selected from the group consisting of 1,4-butanediol diacrylate, 1,6-hexanediol diacrylate, glycerol diacrylate, tripropylene glycol diacrylate, triacrylate trimethylol methane, triacrylate trimethylol ethane, pentaerythritol tetraacrylate, dipentaerythritol tetraacrylate, dipentaerythritol pentaacrylate, dipentaerythritol hexacrylate, and so on. The oligomer can be selected from the group consisting of epoxy acrylate oligomer, epoxy methacrylate oligomer, polyester acrylate oligomer, urethane methacrylate oligomer, urethane acrylate oligomer, amine modified epoxy acrylate, amine modified polyester acrylate, polybutadiene acrylate oligomer, acrylate oligomer, diacrylate oligomer, triacrylate oligomer, and so on. A preferable choice for the non reactive component is macromolecule resin. The macromolecule resin can be selected from the group consisting of acrylate polymer or its derivative, acrylic acid-acrylate polymer or its derivative, and so on.

The solvent of the present ink composition is an organic solvent. The vapor pressure of the solvent is smaller than 0.33 millimeters of mercury (mmHg) at 20° C., but when the temperature of the solvent is between 60° C. and 90° C., the vapor pressure thereof increases at least five times than that of the solvent at 20° C. and/or the evaporation rate is larger than one tenth of that of the butyl acetate at 20° C. The vapor pressure of the solvent at 20° C. preferably ranges from 0.00001 mmHg to 0.33 mmHg, and more preferably ranges from 0.01 mmHg to 0.33 mmHg.

The solvent with above-mentioned features can be at least one selected from but not limited to the group consisting of dipropylene glycol methyl ether, tripropylene glycol methyl ether, dipropylene glycol methyl ether acetate, dipropylene glycol n-propyl ether, dipropylene glycol n-butyl ether, diethylene glycol ethyl ether, diethylene glycol n-butyl ether, ethylene glycol hexyl ether, ethylene glycol phenyl ether, trimethylnonanol, diethylene glycol monomethyl ether, and hexylene glycol. In addition, the above-mentioned solvent can further include other solvents in order to achieve the above feature.

The present ink composition can further includes an initiator and an additive as required. The total amount of the initiator in the ink composition ranges preferably from 0% to 10% by weight, more preferably from 0.1% to 3.5% by weight. The total amount of the additive in the ink composition ranges preferably from 0% to 30% by weight, more preferably from 1% to 10% by weight.

The initiator can be a photo initiator or a thermal initiator. Preferably, the photo initiator can be selected from the group consisting of 1-hydroxy-cyclohexyl-phenyl-ketone, 4,4-bis(dimethylamino), 4,4′-bis(diethylamino)benzophenone, 2-(4-Methoxyphenyl)-4,6-bis(trichloromethyl)-1,3,5-triazine, tris(trichloromethyl)-1,3,5-triazine, Irgacure® 819, Irgacure® 369, Irgacure® 2959, Irgacure® 379, Irgacure® 184, Irgacure® 784, Irgacure® 250, Irgacure® 907, Irgacure® 651, Irgacure® OXE01, Irgacure® 500, Irgacure® 1800, Irgacure® 1000, Irgacure® 1700, Darocure® BP, Darocure® 1173, CGI 242, CGI-552, Chivacure® TPO, Chivacure® TPO-L, Chivacure® 200, Chivacure® 107, Chivacure® 184, and Chivacure® 284. Preferably, the thermal initiator can be selected from the group consisting of benzoyl peroxide, and azobisisobutyronitrile.

According to its property, the additive can be a surfactant, an anti-foaming agent/defoamer, or a dispersant. Preferably, the surfactant can be selected form the group consisting of fluorosurfactant, polymeric fluorosurfactant, siloxane surfactant, polymeric siloxane surfactant, polyoxyethylene surfactants and their derivatives. Preferably, the anti foaming agent/defoamer can be selected form the group consisting of siloxane surfactant, polymeric siloxane surfactant, polyoxyethylene surfactants and their derivatives. Preferably, the dispersant can be selected form the group consisting of acrylate type or modified acrylate type polymeric dispersant, urethane type or modified urethane type polymeric dispersant and other structure of polymeric dispersant. In addition, the general commodity under the trade name of solsperse (Lubrizol Ltd.) can also be used as the dispersant.

A first ink composition in accordance with an embodiment of the present ink composition is comprised of 1 wt % C.I. modified Pigment Red 254, 5 wt % C.I. modified Pigment Yellow 138, 15 wt % dipentaerythritol pentaacrylate, 1 wt % CGI-242, 41 wt % tripropylene glycol methyl ether, 35 wt % diethylene glycol n-butyl ether and 2 wt % solsperse® 24000.

A second composition in accordance with an embodiment of the present ink composition is comprised of 15 wt % C.I. modified Pigment Red 254, 30 wt % dipentaerythritol pentaacrylate, 1 wt % Irgacure® 819, 49 wt % tripropylene glycol methyl ether, 5 wt % solsperse® 24000.

A third ink composition in accordance with an embodiment of the present ink composition is comprised of 4.5 wt % C.I. modified Pigment Red 254, 5 wt % dipentaerythritol pentaacrylate, 5 wt % acrylate polymer, 2 wt % 1-hydroxy-cyclohexyl-phenyl-ketone, 30 wt % propylene glycol methyl ether acetate, 51 wt % tripropylene glycol methyl ether, and 2.5 wt % solsperse® 24000.

A fourth ink composition in accordance with an embodiment of the present ink composition is comprised of 4.5 wt % C.I. modified Pigment Red 254, 2.5 wt % dipentaerythritol pentaacrylate, 7.5 wt % acrylate polymer, 2 wt % 1-hydroxy-cyclohexyl-phenyl-ketone, 48.5 wt % propylene glycol methyl ether acetate, 30 wt % propylene glycol n-butyl ether, and 5 wt % solsperse® 24000.

A fifth ink composition in accordance with an embodiment of the present ink composition is comprised of 5.5 wt % C.I. modified Pigment Red 254, 5 wt % dipentaerythritol pentaacrylate, 5 wt % acrylate polymer, 2 wt % Irgacure® 184, 25 wt % dipropylene glycol methyl ether, 30 wt % propylene glycol methyl ether acetate, 25 wt % tripropylene glycol methyl ether, 2.5 wt % solsperse® 24000.

A sixth ink composition in accordance with an embodiment of the present ink composition is comprised of 5.25 wt % C.I. modified Pigment Red 254, 8 wt % acrylic acid-acrylate polymer, 52.5 wt % dipropylene glycol methyl ether, 31.5 wt % propylene glycol methyl ether acetate, and 2.75 wt % solsperse® 24000.

A seventh ink composition in accordance with an embodiment of the present ink composition is comprised of 3 wt % C.I. modified Pigment Green 36, 6 wt % acrylic acid-acrylate polymer, 36.5 wt % dipropylene glycol methyl ether, 52.5 wt % diethylene glycol ethyl ether, and 2 wt % solsperse® 24000.

An eighth ink composition in accordance with an embodiment of the present ink composition is comprised of 3 wt % C.I. modified Pigment Red 254, 5 wt % urthane acrylate oligomer, 5 wt % acrylate polymer, 2 wt % Irgacure® 184, 82 wt % tripropylene glycol methyl ether, and 3 wt % solsperse® 24000.

A ninth ink composition in accordance with an embodiment of the present ink composition is comprised of 3.5 wt % C.I. modified Pigment Green 36, 0.5% C.I. modified Pigment Yellow 138, 5 wt % urthane acrylate oligomer, 5 wt % acrylate polymer, 2 wt % Irgacure® 819, 55 wt % dipropylene glycol methyl ether acetate, 26 wt % propylene glycol methyl ether acetate, and 3 wt % solsperse® 24000.

A tenth ink composition in accordance with an embodiment of the present ink composition is comprised of 4 wt % C.I. modified Pigment Red 254, 5 wt % acrylate polymer, 87 wt % tripropylene glycol methyl ether, and 4 wt % solsperse® 24000.

An eleventh ink composition in accordance with an embodiment of the present ink composition is comprised of 3 wt % C.I. modified Pigment Red 254, 10 wt % acrylate polymer, 82 wt % dipropylene glycol methyl ether acetate, and 5 wt % solsperse® 24000.

Reference will now be made to the drawings to describe preferred embodiment of the manufacturing method of color filters using the ink composition, in detail.

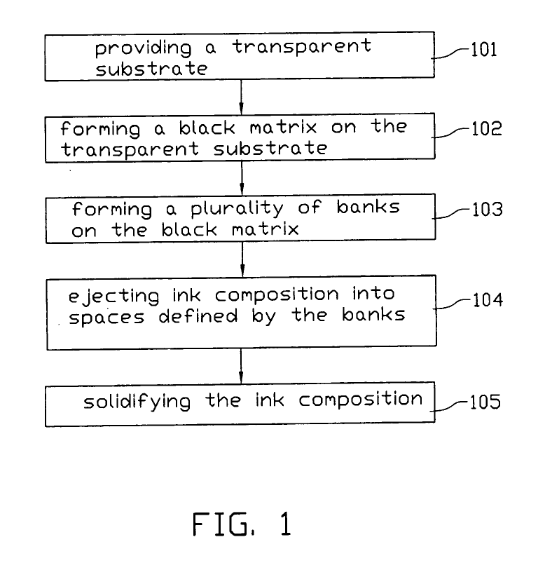

Referring to FIG. 1, a flowchart of a first manufacturing method of color filters in accordance with a preferred embodiment is shown. The manufacturing method mainly includes the steps of: providing a transparent substrate (step 101); forming a black matrix on the transparent substrate (step 102); forming a plurality of banks on the black matrix (step 103); ejecting required color ink composition into spaces defined by the banks via an ink jet device (step 104); and solidifying the ink composition (step 105).

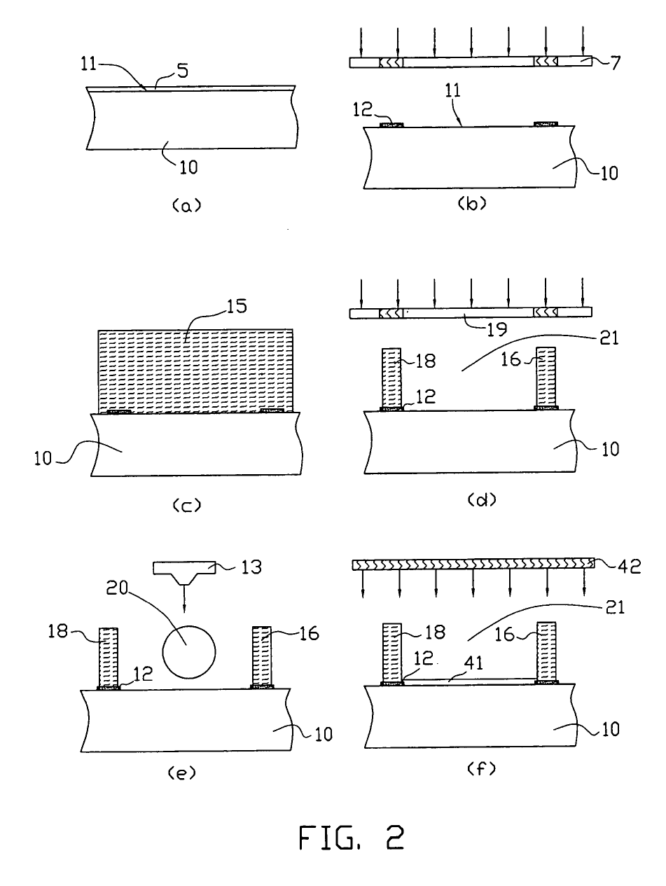

Referring to FIGS. 2(a) to 2(f), more-detailed steps of the manufacturing method are shown. Referring to FIG. 2(a), a transparent plate 10 having an upper surface 11 is provided. A first photoresist layer 5 is formed on the upper surface 11.

Referring to FIG. 2(b), the first photoresist layer 5 is exposed via a photo mask 7 and developed to form a patterned black matrix 12.

Referring to FIG. 2(c), a second photoresist layer 15 is formed on the black matrix 12 and the transparent plate 10 using a wet spin coating method, a spin coating method, a slit coating method, or a slit and spin coating method.

Referring to FIG. 2(d), the second photoresist layer 15 is exposed via a photo mask 19 and developed to form a plurality of banks 16, 18. The banks 16, 18 are formed on the black matrix 12. A space 21 is defined by four banks 16, 18 connected in orthogonal square.

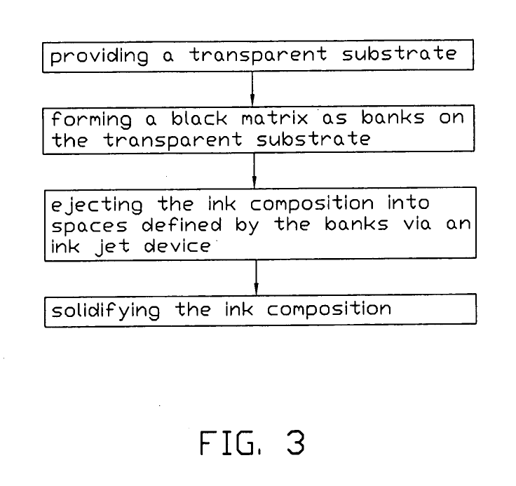

Referring to FIG. 2(e), required color ink drops 20 are ejected into the space 21 using an ink jet device 13, such as a thermal bubble ink jet printing apparatus or a piezoelectric ink jet printing apparatus. The ink drops 20 are mixed together in the space 21 to form an ink composition. On the other way, another type of the black matrix with the similar height of the banks 16, 18 can also be formed on the transparent substrate 10, thus the ink composition can be ejected into spaces defined by the black matrix as the banks via an ink jet device. The flowchart of FIG. 1 can be modified to a second method shown in FIG. 3, where the step of forming the banks can be eliminated.

Referring to FIG. 2(f), the ink composition mixed by ink drops 20 is solidified by a solidifying device 42 to form a flat color layer 41. The flat color layer 41 may be red. Correspondingly, other color layer, such as blue color layer and green color layer may be formed adjacently to the red color layer 41. A heating temperature for the ink composition is higher than a temperature at which the vapor pressure of the solvent in the ink composition is between 0.1 mmHg and 1 mmHg. For example, if the vapor pressure of the solvent in the ink composition is larger than 1 mmHg at 60° C., the heating temperature for the ink composition can be 60° C. or more. A vacuum pump can further be used for solidifying the ink composition. The vacuum for the ink composition is higher than or close to the vapor pressure of the solvent at the heating temperature if the heating device is used. For example, when the heating temperature for the ink composition is at 60° C. or more, the applied vacuum can be in the range from 0.1 mmHg to 5 mmHg, preferably is 1 mmHg. Of course, when the heating temperature is higher, the required vacuum can be lower. The ink composition can further be solidified via a light-emitting device when the ink composition is a kind of cross-linked ink composition.

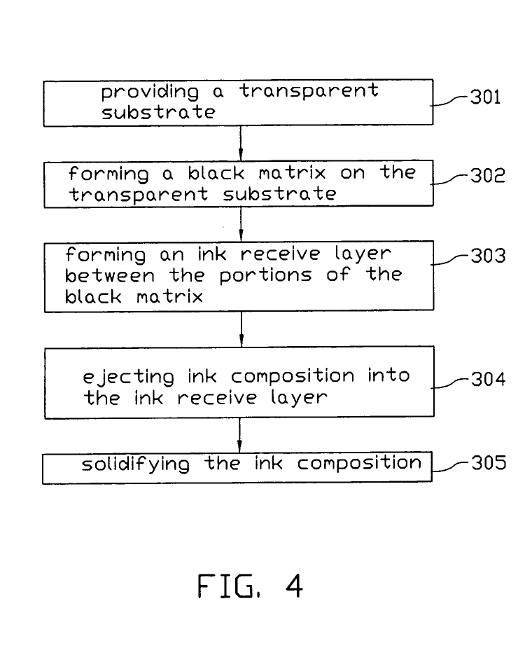

Referring to FIG. 4, a flowchart of a third manufacturing method of color filters in accordance with a preferred embodiment is shown. The method mainly includes the steps of: providing a transparent substrate (step 301); forming a black matrix on the transparent substrate (step 302); forming an ink receive layer between the portions of the black matrix (step 303); ejecting required color ink composition into the ink receive layer (step 304); and solidifying the ink composition (step 305).

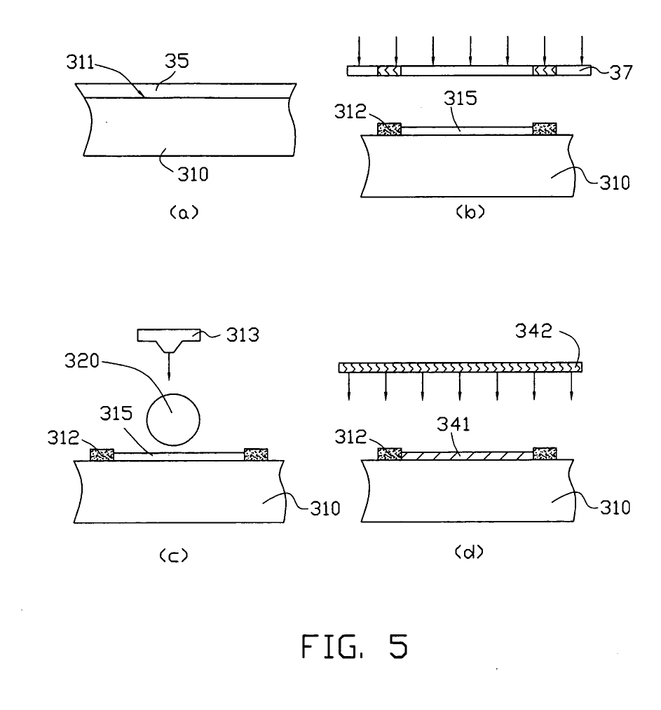

Referring to FIGS. 5(a) to 5(d), more-detailed steps of the manufacturing method are shown. Referring to FIG. 5(a), a transparent plate 310 having an upper surface 311 is provided. A first photoresist layer 35 is formed on the upper surface 311.

Referring to FIG. 5(b), the first photoresist layer 35 is exposed via a photo mask 37 and developed to form a patterned black matrix 312. An ink receive layer 315 is coated between the black matrix 312. A material of the ink receive layer 315 can be a mixture of macromolecule adhesive and silica, or metal oxide.

Referring to FIG. 5(c), required color ink drops 320 are ejected into the ink receive layer 315 using an ink jet device 313, such as a thermal bubble ink jet printing apparatus or a piezoelectric ink jet printing apparatus.

Referring to FIG. 5(d), the ink composition is solidified by a heating device 342, and the ink receive layer 315 and the ink composition therein change into a flat color layer 341 according to the color of the ink composition, but when the vapor pressure of the solvent in the ink composition is larger than 0.1 mmHg at 60° C., a heating temperature for the ink composition can be 60° C. or more. A vacuum pump can further be used for solidifying the ink composition. A vacuum for the ink composition is higher than or close to the vapor pressure of the solvent at the heating temperature if the heating device is used. For example, when the heating temperature for the ink composition can is 60° C. or more, the applied vacuum can be in the range from 0.1 mmHg to 5 mmHg, preferably is 0.1 mmHg. The ink composition can further be solidified via a light-emitting device when the ink composition is a kind of cross-linked ink composition.

Because the present ink composition contains the solvent with a vapor pressure smaller than 0.33 mmHg at 20° C., it has a low rate of drying and cannot block the ink jet head, but when the present ink composition is ejected onto the transparent substrate and is heated to/more than a temperature between 60° C. and 90° C., it has a high rate of drying, thus the manufacturing rate of color filters is improved. The present ink composition has excellent practicability.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. An ink composition, comprising:
a colorant;
at least one component selected from the group consisting of monomer, oligomer, and macromolecule resin; and
a solvent, wherein the vapor pressure of the solvent is smaller than 0.33 mmHg at 20° C., when the temperature of the solvent is between 60° C. and 90° C., the vapor pressure thereof increases at least five times than that of the solvent at 20° C. and/or the evaporation rate is larger than one tenth of that of butyl acetate at 20° C.

2. The ink composition as claimed in claim 1, wherein the total amount of the colorant in the ink composition ranges from 0.1 wt % to 30 wt %.

3. The ink composition as claimed in claim 2, wherein the total amount of the colorant in the ink composition ranges from 2 wt % to 15 wt %.

4. The ink composition as claimed in claim 1, wherein the total amount of the at least one component selected from the group consisting of monomer, oligomer, and macromolecule resin in the ink composition ranges from 1 wt % to 80 wt %.

5. The ink composition as claimed in claim 4, wherein the total amount of the at least one component selected from the group consisting of monomer, oligomer, and macromolecule resin in the ink composition ranges from 5 wt % to 30 wt %.

6. The ink composition as claimed in claim 1, wherein the total amount of the solvent in the ink composition ranges from 15 wt % to 95 wt %.

7. The ink composition as claimed in claim 6, wherein the total amount of the solvent in the ink composition ranges from 60 wt % to 85 wt %.

8. The ink composition as claimed in claim 1, wherein the vapor pressure of the solvent at 20° C. ranges from 0.00001 mmHg to 0.33 mmHg.

9. The ink composition as claimed in claim 8, wherein the vapor pressure of the solvent at 20° C. ranges from 0.01 mmHg to 0.33 mmHg.

10. The ink composition as claimed in claim 1, wherein the colorant is one of pigment and dye.

11. The ink composition as claimed in claim 10, wherein the colorant is at least one pigment selected from the group consisting of C.I. Pigment Red 122, C.I. Pigment Red 177, C.I. Pigment Red 185, C.I. Pigment Red 202, C.I. Pigment Red 206, C.I. Pigment Red 207, C.I. Pigment Red 209, C.I. Pigment Red 224, C.I. Pigment Red 254, C.I. Pigment Red 264, C.I. Pigment Blue 15:3, C.I. Pigment Blue 15:4, C.I. Pigment Blue 15:6, C.I. Pigment Green 7, C.I. Pigment Green 36, C.I. Pigment Yellow 74, C.I. Pigment Yellow 83, C.I. Pigment Yellow 110, C.I. Pigment Yellow 138, C.I. Pigment Yellow 139, C.I. Pigment Yellow 150, C.I. Pigment Yellow 151, C.I. Pigment Yellow 155, C.I. Pigment Yellow 180, C.I. Pigment Yellow 213, C.I. Pigment Orange 38, C.I. Pigment Orange 73, C.I. Pigment Brown 24, C.I. Pigment Violet 19, and C.I. Pigment Violet 23.

12. The ink composition as claimed in claim 1, wherein the monomer is selected from the group consisting of 1,4-butanediol diacrylate, 1,6-hexanediol diacrylate, glycerol diacrylate, tripropylene glycol diacrylate, triacrylate trimethylol methane, triacrylate trimethylol ethane, pentaerythritol tetraacrylate, dipentaerythritol tetraacrylate, dipentaerythritol pentaacrylate, and dipentaerythritol hexacrylate.

13. The ink composition as claimed in claim 1, wherein the oligomer is selected from the group consisting of epoxy acrylate oligomer, epoxy methacrylate oligomer; polyester acrylate oligomer, urethane methacrylate oligomer, urethane acrylate oligomer, amine modified epoxy acrylate, amine modified polyester acrylate, polybutadiene acrylate oligomer, acrylate oligomer, diacrylate oligomer, triacrylate oligomer, and carbamate oligomer.

14. The ink composition as claimed in claim 1, wherein the macromolecule resin is selected from the group consisting of acrylate polymer or its derivative, and acrylic acid-acrylate polymer or its derivative.

15. The ink composition as claimed in claim 1, wherein the solvent is an organic solvent.

16. The ink composition as claimed in claim 1, wherein the solvent is at least one selected from the group consisting of dipropylene glycol methyl ether, tripropylene glycol methyl ether, dipropylene glycol methyl ether acetate, dipropylene glycol n-propyl ether, dipropylene glycol n-butyl ether, diethylene glycol ethyl ether, diethylene glycol n-butyl ether, ethylene glycol hexyl ether, ethylene glycol phenyl ether, trimethylnonanol, diethylene glycol monomethyl ether, and hexylene glycol.

17. The ink composition as claimed in claim 1, further comprising an initiator ranging from 0 wt % to 10 wt %.

18. The ink composition as claimed in claim 17, wherein the initiator ranges from 0.1 wt % to 3.5 wt %.

19. The ink composition as claimed in claim 1, further comprising an additive ranging from 0 wt % to 30 wt %.

20. The ink composition as claimed in claim 19, wherein the additive ranges from 1 wt % to 10 wt %.

21. The ink composition as claimed in claim 17, wherein the initiator is one of a photo initiator and a thermal initiator.

22. The ink composition as claimed in claim 17, wherein the initiator is selected from the group consisting of 1-hydroxy-cyclohexyl-phenyl-ketone, 4,4-bis(dimethylamino), 4,4′-bis(diethylamino)benzophenone, 2-(4-Methoxyphenyl)-4,6-bis(trichloromethyl)-1,3,5-triazine, tris(trichloromethyl)-1,3,5-triazine, Irgacure® 819, Irgacure® 369, Irgacure® 2959, Irgacure® 379, Irgacure® 184, Irgacure® 784, Irgacure® 250, Irgacure® 907, Irgacure® 651, Irgacure® OXE01, Irgacure® 500, Irgacure® 1800, Irgacure® 1000, Irgacure® 1700, Darocure® BP, Darocure® 1173, CGI 242, CGI-552, Chivacure® TPO, Chivacure® TPO-L, Chivacure® 200, Chivacure® 107, Chivacure® 184, Chivacure® 284, benzoyl peroxide, and azobisisobutyronitrile.

23. The ink composition as claimed in claim 19, wherein the additive is selected form the group consisting of a surfactant, an anti foaming agent/defoamer, and a dispersant.

24. The ink composition as claimed in claim 23, wherein the surfactant is selected form the group consisting of fluorosurfactant, polymeric fluorosurfactant, siloxane surfactant, polymeric siloxane surfactant, polyoxyethylene surfactants and their derivatives, the anti foaming agent/defoamer is selected form the group consisting of siloxane surfactant, polymeric siloxane surfactant, polyoxyethylene surfactants and their derivatives, the dispersant is selected form the group consisting of acrylate type or modified acrylate type polymeric dispersant, urethane type or modified urethane type polymeric dispersant and other structure of polymeric dispersant.

25. The ink composition as claimed in claim 23, wherein the dispersant is solsperse®.

26. The ink composition as claimed in claim 1, wherein the ink composition is selected from the group consisting of a first composition comprised of 1 wt % C.I. modified Pigment Red 254, 5 wt % C.I. modified Pigment Yellow 138, 15 wt % dipentaerythritol pentaacrylate, 1 wt % CGI-242, 41 wt % tripropylene glycol methyl ether, 35 wt % diethylene glycol n-butyl ether and 20 wt % solsperse® 24000, and a second composition comprised of 15 wt % C.I. modified Pigment Red 254, 30 wt % dipentaerythritol pentaacrylate, 1 wt % Irgacure® 819, 49 wt % tripropylene glycol methyl ether, and 5 wt % solsperse® 24000, and a third composition comprised of 4.5 wt % C.I. modified Pigment Red 254, 5 wt % dipentaerythritol pentaacrylate, 5 wt % acrylate polymer, 2 wt % 1-hydroxy-cyclohexyl-phenyl-ketone, 30 wt % propylene glycol methyl ether acetate, 51 wt % tripropylene glycol methyl ether, and 2.5 wt % solsperse® 24000, and a fourth composition comprised of 4.5 wt % C.I. modified Pigment Red 254, 2.5 wt % dipentaerythritol pentaacrylate, 7.5 wt % acrylate polymer, 2 wt % 1-hydroxy-cyclohexyl-phenyl-ketone, 48.5 wt % propylene glycol methyl ether acetate, 30 wt % propylene glycol n-butyl ether, and 5.0 wt % solsperse® 24000, and a fifth composition comprised of 5.5 wt % C.I. modified Pigment Red 254, 5 wt % dipentaerythritol pentaacrylate, 5 wt % acrylate polymer, 2 wt % Irgacure® 184, 25 wt % dipropylene glycol methyl ether, 30 wt % propylene glycol methyl ether acetate, 25 wt % tripropylene glycol methyl ether, and 2.5 wt % solsperse® 24000, and a sixth composition comprised of 5.25 wt % C.I. modified Pigment Red 254, 8 wt % acrylic acid-acrylate polymer, 52.5 wt % dipropylene glycol methyl ether, 31.5 wt % propylene glycol methyl ether acetate, and 2.75 wt % solsperse® 24000, and a seventh composition comprised of 3 wt % C.I. modified Pigment Green 36, 6 wt % acrylic acid-acrylate polymer, 36.5 wt % dipropylene glycol methyl ether, 52.5 wt % diethylene glycol ethyl ether, and 2 wt % solsperse® 24000, and an eighth composition comprised of 3 wt % C.I. modified Pigment Red 254, 5 wt % urtahne acrylate oligomer, 5 wt % acrylate polymer, 2 wt % Irgacure® 184, 82 wt % tripropylene glycol methyl ether, and 3 wt % solsperse® 24000, and ninth composition comprised of 3.5 wt % C.I. modified Pigment Green 36, 0.5% C.I. modified Pigment Yellow 138, 5 wt % urthane acrylate oligomer, 5 wt % acrylate polymer, 2 wt % Irgacure® 819, 55 wt % dipropylene glycol methyl ether acetate, 26 wt % propylene glycol methyl ether acetate, and 3 wt % solsperse® 24000, and a tenth composition comprised of 4 wt % C.I. modified Pigment Red 254, 5 wt % acrylate polymer, 87 wt % tripropylene glycol methyl ether, and 4 wt % solsperse® 24000, and an eleventh composition comprised of 3 wt % C.I. modified Pigment Red 254, 10 wt % acrylate polymer, 82 wt % dipropylene glycol methyl ether acetate, and 5 wt % solsperse® 24000.

27. An ink composition, comprising:
a colorant;
at least one component selected from the group consisting of monomer, oligomer, and macromolecule resin; and
a mixed solvent, wherein the vapor pressure of the mixed solvent is smaller than 0.33 mmHg at 20° C., when the temperature of the mixed solvent is between 60° C. and 90° C., the vapor pressure thereof increases at least five times than that of the mixed solvent at 20° C. and/or the evaporation rate is larger than one tenth of that of butyl acetate at 20° C.

28. A manufacturing method of color filter, comprising the steps of:
providing a transparent substrate;
forming a black matrix on the transparent substrate;
forming a plurality of banks on the black matrix;
ejecting an ink composition into spaces defined by the banks via an ink jet device, the ink composition comprising:
a colorant;
at least one component selected from the group consisting of monomer, oligomer, and macromolecule resin; and
a solvent, wherein the vapor pressure of the solvent is smaller than 0.33 mmHg at 20° C., when the temperature of the solvent is between 60° C. and 90° C., the vapor pressure thereof increases at least five times than that of the solvent at 20° C. and/or the evaporation rate is larger than one tenth of that of butyl acetate at 20° C.; and
solidifying the ink composition.

29. The method as claimed in claim 28, wherein the ink composition is solidified by a heating process to remove the solvent therein.

30. The method as claimed in claim 28, wherein the ink composition is solidified by a heating process and a vacuum pumping process to remove the solvent therein.

31. The method as claimed in claim 29, wherein a heating temperature for the ink composition is higher than a temperature at which the vapor pressure of the solvent in the ink composition is between 0.1 mmHg and 1 mmHg.

32. The method as claimed in claim 30, wherein a heating temperature for the ink composition is higher than a temperature at which the vapor pressure of the solvent in the ink composition is between 0.1 mmHg and 1 mmHg.

33. The method as claimed in claim 31, wherein the heating temperature for the ink composition is between 60° C. and 90° C. or more.

34. The method as claimed in claim 32, wherein the heating temperature for the ink composition is between 60° C. and 90° C. or more.

35. The method as claimed in claim 28, wherein the ink composition is solidified by one of a heating device and a light-emitting device.

36. The method as claimed in claim 32, wherein a vacuum for the ink composition is higher than or close to the vapor pressure of the solvent at the heating temperature.

37. The method as claimed in claim 36, wherein the vacuum is in the range from 0.1 mmHg to 5 mmHg.

38. The method as claimed in claim 28, wherein the ink jet device is one of a thermal bubble ink jet printing apparatus and a piezoelectric ink jet printing apparatus.

39. A manufacturing method of color filter, comprising the steps of:
providing a transparent substrate,
forming a black matrix on the transparent substrate;
forming an ink receive layer between the portions of the black matrix;
ejecting an ink composition into the ink receive layer, the ink composition comprising:
a colorant;
at least one component selected from the group consisting of monomer, oligomer, and macromolecule resin; and
a solvent, wherein the vapor pressure of the solvent is smaller than 0.33 mmHg at 20° C., when the temperature of the solvent is between 60° C. and 90° C., the vapor pressure thereof increases at least five times than that of the solvent at 20° C. and/or the evaporation rate is larger than one tenth of that of butyl acetate at 20° C., and
solidifying the ink composition.

40. The method as claimed in claim 39, wherein the ink composition is solidified by a heating process to remove the solvent therein.

41. The method as claimed in claim 39, wherein the ink composition is solidified by a heating process and a vacuum pumping process to remove the solvent therein.

42. The method as claimed in claim 40, wherein a heating temperature for the ink composition is higher than a temperature at which the vapor pressure of the solvent in the ink composition is between 0.1 mmHg and 1 mmHg.

43. The method as claimed in claim 41, wherein a heating temperature for the ink composition is higher than a temperature at which the vapor pressure of the solvent in the ink composition is between 0.1 mmHg and 1 mmHg.

44. The method as claimed in claim 42, wherein the heating temperature for the ink composition is between 60° C. and 90° C. or more.

45. The method as claimed in claim 43, wherein the heating temperature for the ink composition is between 60° C. and 90° C. or more.

46. The method as claimed in claim 39, wherein the ink composition is solidified by one of a heating device and a light-emitting device.

47. The method as claimed in claim 43, wherein a vacuum for the ink composition is higher than or close to the vapor pressure of the solvent at the heating temperature.

48. The method as claimed in claim 47, wherein the vacuum is in the range from 0.1 mmHg to 5 mmHg.

49. A manufacturing method of color filter, comprising the steps of:
providing a transparent substrate;
forming a black matrix as banks on the transparent substrate;
ejecting an ink composition into spaces defined by the banks via an ink jet device, the ink composition comprising:
a colorant;
at least one component selected from the group consisting of monomer, oligomer, and macromolecule resin; and
a solvent, wherein the vapor pressure of the solvent is smaller than 0.33 mmHg at 20° C., when the temperature of the solvent is between 60° C. and 90° C., the vapor pressure thereof increases at least five times than that of the solvent at 20° C. and/or the evaporation rate is larger than one tenth of that of butyl acetate at 20° C.; and
solidifying the ink composition.

50. The method as claimed in claim 49, wherein the ink composition is solidified by a heating process to remove the solvent therein.

51. The method as claimed in claim 49, wherein the ink composition is solidified by a heating process and a vacuum pumping process to remove the solvent therein.

52. The method as claimed in claim 50, wherein a heating temperature for the ink composition is higher than a temperature at which the vapor pressure of the solvent in the ink composition is between 0.1 mmHg and 1 mmHg.

53. The method as claimed in claim 51, wherein a heating temperature for the ink composition is higher than a temperature at which the vapor pressure of the solvent in the ink composition is between 0.1 mmHg and 1 mmHg.

54. The method as claimed in claim 52, wherein the heating temperature for the ink composition is between 60° C. and 90° C. or more.

55. The method as claimed in claim 53, wherein the heating temperature for the ink composition is between 60° C. and 90° C. or more.

56. The method as claimed in claim 49, wherein the ink composition is solidified by one of a heating device and a light-emitting device.

57. The method as claimed in claim 53, wherein a vacuum for the ink composition is higher than or close to the vapor pressure of the solvent at the heating temperature.

58. The method as claimed in claim 57, wherein the vacuum is in the range from 0.1 mmHg to 5 mmHg.
